(19) United States
(12) Patent Application Publication
(10) Pub. No.: US 2006/0206911 A1
(43) Pub. Date: Sep. 14, 2006

(54) Security camera employing privacy protection method

(75) Inventors: Hak Je Kim, Suwon-Si (KR); Jin Weon Choi, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/325,344

(22) Filed: Jan. 5, 2006

(30) Foreign Application Priority Data
Mar. 8, 2005 (KR) 2005-19131

(51) Int. Cl. H04H 9/00; H04N 7/16

(52) U.S. Cl. 725/12

(57) ABSTRACT

A security camera employing a privacy protection method is disclosed. The security camera comprises a lens unit, a pan/tilt/zoom drive for operating the lens unit, an image processor for generating an original image captured by the lens unit, a privacy area processor for reducing resolution of a privacy area when a predetermined area of the original image is a privacy area, and generating a resultant image including the privacy area displayed at low resolution, and an output unit for transmitting a variety of images to a display.

### PRIORITY

This application claims the benefit under 35 U.S.C. § 119(a) of Korean Patent Application No. 2005-19131, filed on Mar. 8, 2005, in the Korean Intellectual Property Office, the entire disclosure of which is hereby incorporated by reference.

### BACKGROUND OF THE INVENTION

1. Field of the Invention

The present invention relates to a security camera employing a privacy protection method. More particularly, the present invention relates to a security camera employing a privacy protection method that reduces the resolution of a privacy area captured by the security camera, and displays a desired image, which includes display of the privacy area in low resolution, thus resulting in the protection of a person's privacy.

2. Description of the Related Art

Security cameras have been widely installed in buildings or on streets as deterrents to crimes or burglaries. Images captured by security cameras are displayed on monitors within police stations or in building management rooms. Therefore, a police officer or building superintendent can monitor a current situation of a specific location at which the security camera is installed. A system for displaying the images captured by the security cameras on a variety of displays is referred to as a security system. A conventional security system includes a security camera, a controller, and a monitor, as shown in FIG. 13 of Japanese Laid-open Patent Application No. 2001-69454, the entire contents of which are hereby incorporated by reference.

The security camera includes a lens unit for capturing a predetermined security area, a pan/tilt/zoom drive for performing a panning rotation in a horizontal direction of 360°, a tilting operation in a vertical direction of 180°, and a zooming operation. The security camera also includes a controller for controlling operations of the camera. The controller includes a variety of keys and a joystick for controlling the security camera. A user may control multiple security cameras using the controller. The monitor displays images of a monitored area captured by the security camera.

If the above-mentioned security system is completely installed, the user controls the security camera to face a specific direction to be monitored and checks images displayed on a monitor. In this manner a user can determine the presence or absence of a crime or burglary in the monitored area. Therefore, if the security system is installed in a dangerous area having a high crime rate, the crime rate may be decreased.

On the other hand, conventional security systems capture and display images of a person irrespective of privacy, resulting in the occurrence of an invasion of a person's privacy. Therefore, the above-mentioned Japanese Laid-open Patent Application No. 2001-69494 has disclosed a method for masking a specific image corresponding to a person's privacy, and preventing the specific image from being displayed on a monitor, thereby protecting a person's privacy. In more detail, as shown in FIG. 1, the privacy area “A” contained in an overall image displayed on the monitor is masked, such that an actual image is not displayed within the privacy area. However, if a privacy area is masked as shown in the above-mentioned Japanese Patent Laid-open No. 2001-69494, the person's privacy may be protected but the privacy area is incapable of being monitored, thus the functions of the security camera are not effectively performed. Also, there is no image within the privacy area so the displayed image becomes awkward. Accordingly, what is needed is a security camera that can effectively perform its necessary functions yet maintain the privacy of individuals recorded.

### SUMMARY OF THE INVENTION

Aspects of the invention provide a security camera employing a privacy protection method for protecting a person's privacy, and at the same time maintaining a security function even in a privacy area.

In accordance with one aspect of the present invention, the above and other aspects can be achieved by providing a security camera comprising a lens unit, a pan/tilt/zoom drive for operating the lens unit, an image processor for generating an original image captured by the lens unit, a privacy area processor for reducing resolution of a privacy area when a predetermined area of the original image is a privacy area, and generating a resultant image including the privacy area of low resolution, and an output unit for transmitting a variety of images to a display.

In one exemplary embodiment of the present invention, the resolution of the privacy area is reduced because the privacy area is distorted by a mosaic. The size of the mosaic can change according to a zoom ratio of the security camera.

In accordance with another aspect of the present invention, there is provided a security camera comprising a lens unit, a pan/tilt/zoom drive for operating the lens unit, an image processor for generating an original image captured by the lens unit, a bitmap generator for constructing a bitmap of the original image, a resampling unit for generating a resampling image formed when the original image is divided into a plurality of blocks according to the resolution of the bitmap, a mosaic synthesizer for converting only a privacy area of the original image into a resampling image indicative of an image distorted by a mosaic according to the bitmap, and an output unit for transmitting a variety of images to a display.

In accordance with yet another aspect of the present invention, there is provided a privacy protection method for use in a security camera including a lens unit, a pan/tilt/zoom drive for operating the lens unit, and an image processor for generating an original image captured by the lens unit. The method comprises determining whether the original image includes a privacy area, and generating a new image in which resolution of the privacy area is reduced when the privacy area is in the original image.

In one exemplary embodiment of the present invention, the resolution of the privacy area is reduced because the privacy area is distorted by a mosaic. The size of the mosaic can change according to a zoom ratio of the security camera or the degree of privacy protection.

In another exemplary embodiment of the present invention, generating a new image comprises generating a bitmap of the original image, generating a resampling image formed when the original image is divided into a plurality of blocks according to resolution of the bitmap, and combining the original image and the resampling image on the basis of the bitmap, whereby the new image is constructed.

In accordance with one aspect of the present invention, the mosaic size is changed according to the degree of privacy protection desired.

In accordance with another aspect of the present invention, the privacy area processor comprises a privacy area calculator for calculating the privacy area contained in the original image in consideration of privacy position information stored in a privacy area storage unit and a pan/tilt/zoom degree of the lens unit. The privacy area processor can comprise a bitmap generator for constructing a bitmap of the original image including the privacy area.

The privacy area processor may also comprise a resampling unit for dividing the original image into a plurality of blocks according to resolution of the bitmap, and generating a resampling image in which a mean value of brightness signals of all pixels contained in each divided block is set to a brightness signal value of the block and a mean value of chrominance signal values of all pixels contained in the block is set to a chrominance signal value of the block.

And the privacy area processor comprises a mosaic synthesizer for selecting the resampling image in the privacy area from among the overall bitmaps, and selecting the original image in the remaining area other than the privacy area such that the privacy area is distorted by a mosaic by the resampling image.

In another exemplary embodiment, the security camera further comprises an upper/lower inverting unit for vertically inverting the images if a tilt angle of the lens unit is in a predetermined range, and transmitting the inverted images to the output unit.

In accordance with one aspect of the present invention, the size of the mosaic is determined according to a size of the block. In accordance with another aspect of the present invention, the privacy area contained in the original image is replaced with the resampling image.

### BRIEF DESCRIPTION OF THE DRAWINGS

The above aspects and exemplary features of the present invention will become more apparent by describing in detail certain embodiments with reference to the accompanying drawings, in which:

FIG. 1 depicts a conceptual diagram illustrating a conventional privacy protection method for protecting a person's privacy by masking a privacy area;

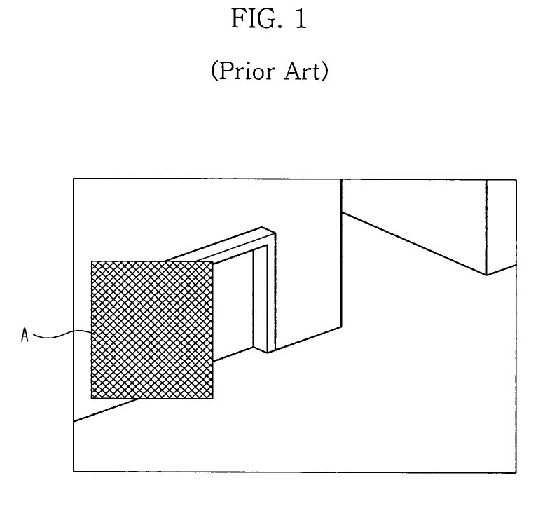

FIG. 2 shows a block diagram illustrating a security camera in accordance with an exemplary embodiment of the present invention;

FIG. 3 shows an original image generated from an image processor, and a bitmap image of the original image according to an exemplary embodiment of the present invention;

FIG. 4 shows an original image generated from an image processor, and a resampling image in which the original image is reconstructed in the form of a plurality of blocks according to an exemplary embodiment of the present invention;

FIG. 5 shows a mosaic image formed by combining an original image and a resampling image according to an exemplary embodiment of the present invention; and

FIG. 6 shows a flow chart illustrating a privacy protection method for use in a security camera shown in FIG. 2.

Throughout the drawings, like reference numbers should be understood to refer to like elements, features, and structures.

### DETAILED DESCRIPTION OF EXEMPLARY EMBODIMENTS

The matters exemplified in this description are provided to assist in a comprehensive understanding of various exemplary embodiments of the present invention disclosed with reference to the accompanying figures. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness.

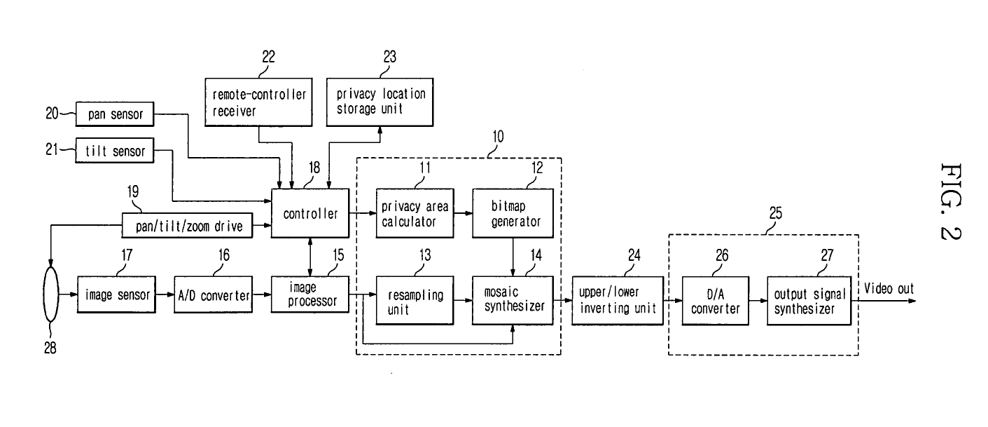

FIG. 2 shows a block diagram illustrating a security camera in accordance with a preferred embodiment of the present invention. In reference to FIG. 2, a security camera according to an exemplary embodiment of the present invention comprises a lens unit 28, an image sensor 17, an Analog-to-Digital (A/D) converter 16, an image processor 15, a controller 18, a privacy location storage unit 23, and a privacy area processor 10. The security camera further comprises a pan/tilt/zoom drive 19, a pan sensor 20, a tilt sensor 21, a remote-controller receiver 22, a upper/lower inverting unit 24, and an output unit 25.

The image sensor 17 comprises a Charge Coupled Device (CCD) device for capturing a desired image, and converts an optical signal received in the lens unit 28 into an electric signal. The A/D converter 16 converts the electric signal generated from the image sensor 17 into a digital signal. The image processor 15 compensates for digital signal quality, synthesizes a brightness signal (Y) and chrominance signals Cr and Cb, and outputs an original image.

The privacy location storage unit 23 stores a plurality of data units indicative of a privacy area. In one aspect of the present invention, the privacy location storage unit 23 stores pan and tilt angles at which the security camera captures an image of the privacy area, stores coordinate values of the privacy area included in individual images, and stores coordinate values of a privacy area varying with a zoom ratio.

By way of non-limiting example, a security camera's image pickup direction including the privacy area is determined to be a predetermined condition in which a pan angle of 60°˜90° and a tilt angle of 0°˜20° are provided. The security camera captures individual images provided when the pan angle and the tilt angle are changed in the ranges of 60°˜90° and 0°˜20°, respectively, and the privacy location storage unit 23 stores coordinate values of the privacy area contained in the captured images as necessary data. Also, the privacy location storage unit 23 stores coordinate values of the privacy area differently captured when a zoom ratio is set to a 3× zoom ratio or a 5× zoom ratio. A user can determine whether the security camera captures the privacy area using the pan angle and the tilt angle of the security camera. The privacy area contained in the captured image can be recognized using coordinate values of the privacy area varying with the zoom ratio.

The privacy area processor 10 comprises a privacy area calculator 11, a bitmap generator 12, a resampling unit 13, and a mosaic synthesizer 14 in order to provide a mosaic over the privacy area. The privacy area calculator 11 determines whether a current recorded image includes a privacy area using signals fed back from the pan sensor 20, the tilt sensor 21, and the pan/tilt/zoom drive 19 to the controller 18. If the current recorded image includes a privacy area, the privacy area calculator 11 determines the position of the privacy area using the same signals fed back from the pan sensor 20, the tilt sensor 21, and the pan/tilt/zoom drive 19 to the controller 18.

If the pan and tilt angles of the lens unit 28 are equal to individual angles at which the privacy area can be captured on the basis of position detected by the pan and tilt sensors 20 and 21, the privacy area calculator 11 determines that the security camera has captured the privacy area, and calculates the position of the privacy area contained in a corresponding image on the basis of zoom ratio and the privacy area's coordinate values stored in the privacy location storage unit 23.

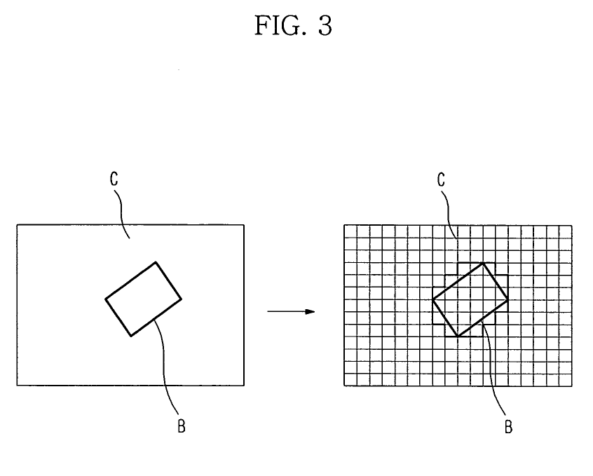

The bitmap generator 12 constructs a privacy area calculated by the privacy area calculator 11 and bitmap data of the remaining areas other than the privacy area at predetermined intervals of time. For example, as shown in the left drawing of FIG. 3, if a predetermined area B contained in the original image is defined as a privacy area calculated by the privacy area calculator 11, the bitmap generator 12 constructs a bitmap image of the privacy area B and another bitmap image of the remaining area C, which is the area other than privacy area B, that is the non-privacy area, as shown by the drawing on the right in FIG. 3.

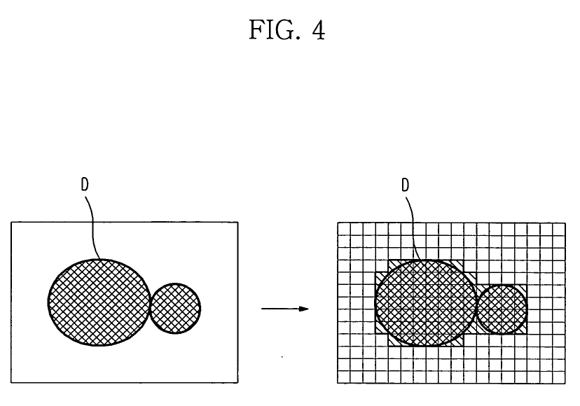

The resampling unit 13 reconstructs the original image generated from the image processor 15 using a plurality of blocks. A brightness signal value and a chrominance signal value of each block are determined to be a mean value of brightness of all pixels of the block, and a mean value of chrominance of all pixels of the block, respectively. As shown in FIG. 4, the resampling unit 13 reconstructs the original image using a plurality of blocks denoted by i*j (where i and j are natural numbers larger than 1). For reference, as can be seen from the circumference of object D shown in FIG. 4, a mean value of brightness of all pixels contained in a corresponding block is indicative of the brightness of a corresponding block, and a mean value of chrominance of all pixels contained in the block is indicative of the chrominance of the corresponding block, such that the color of the circumference is lighter than in the center part of the object D.

In one exemplary embodiment of the present invention, the resampling operation is performed at intervals of a predetermined time in the same manner as in the bitmap operation, and the size of a resampling image block is changed according to the degree of privacy protection desired, because the size of the block acts as a mosaic piece. If the size of the block is large, the size of the mosaic piece is also large, resulting in a deterioration of resolution of the original image. If the size of the block is small, the size of the mosaic piece is also small, resulting in increased resolution of the original image. Therefore, the resolution of the privacy area can be adjusted according to the size of the block, and the size of the block can be established according to the degree of privacy area protection and resolution desired.

For areas requiring a high degree of privacy protection, resampling unit 13 sets the block size to a large-sized block (that is, the size of the mosaic piece of the privacy area is increased), and the resolution of the specific area within the block is correspondingly lowered. Conversely, resampling unit 13 sets the block size to a small-sized block (that is, the size of the mosaic piece of the privacy area is decreased), and the resolution of the area within the block is correspondingly increased.

Preferably, the block size is changed according to zoom ratio. If the zoom ratio is changed, the size of the privacy area displayed on a monitor is also changed. Therefore, the block size changes according to change in zoom ratio, and the size of the mosaic piece contained in the mosaic image is also changed.

The block size may also change according to resolution of the bitmap. When forming a mosaic image, the privacy area and the remaining non-privacy area require different video signals based on the bitmap. Therefore, if a bitmap resolution and block size of the privacy area are different from that of the non-privacy area, an unnatural image may unexpectedly form at the boundary between the privacy area and the non-privacy area.

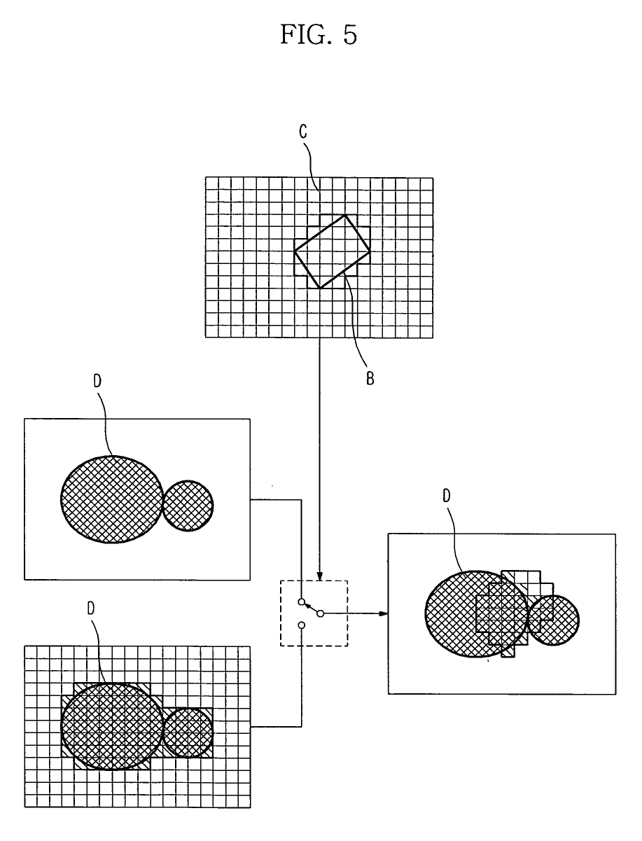

The mosaic synthesizer 14 constructs a new image in which the privacy area is distorted by a mosaic. As shown in FIG. 5, the mosaic synthesizer 14 performs a switching operation on the basis of the desired bitmap. A block for the non-privacy area contained in the bitmap defines brightness and chrominance values for the original image, and for the privacy area contained in the bitmap, the block defines brightness and chrominance values for a resampling image, such that a mosaic image is formed in which only the privacy area is distorted by a mosaic. As can be seen from the drawing on the right in FIG. 5, the size of the mosaic piece is equal to the block size of the resampling image. In this manner, the remaining non-privacy area retains the original image and only the privacy area is distorted by a mosaic, thus resulting in the protection of privacy.

The pan/tilt/zoom drive 19 allows the lens unit 28 to perform pan rotation, tilt rotation, and a zoom operation. If the lens unit 28 is recognized by the pan sensor 20, the pan angle of 0°˜360° of lens unit 28 is 0°. If the lens unit 28 is recognized by tilt sensor 21, the tilt angle of 0°˜180° of lens unit 28 is 0°. The upper/lower inverting unit 24 vertically inverts an image captured at a tilt angle of 90°˜180°, and it prevents the image captured at the tilt angle of 90°˜180° from being turned over. The output unit 25 includes a Digital-to-Analog (D/A) converter 26 for converting the image generated from the upper/lower inverting unit 24 into an analog signal, and an output signal synthesizer 27 for synthesizing an analog brightness signal and an analog chrominance signal, and generating a composite video signal.

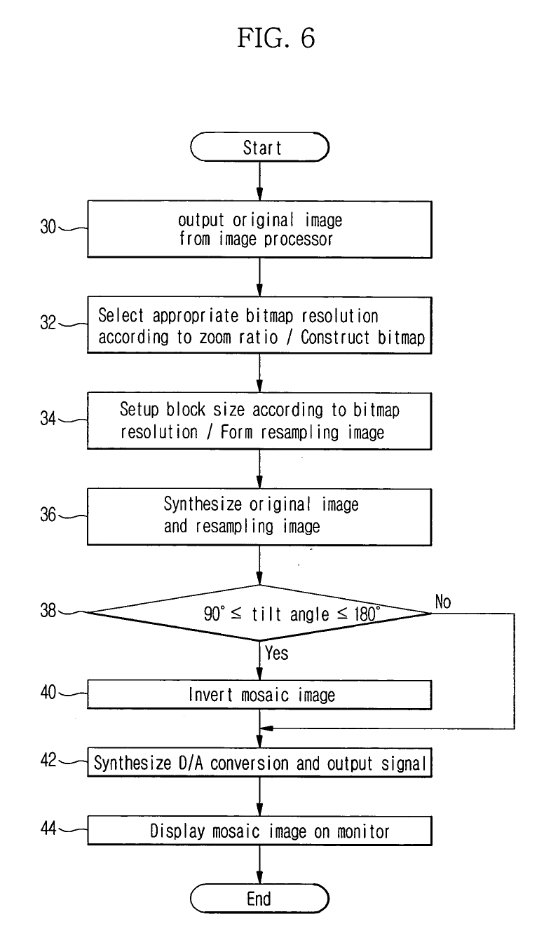

A privacy protection method for use in a security camera according to an exemplary embodiment of the present invention will hereinafter be described with reference to FIG. 6. Referring to FIG. 6, if the security camera is installed and a user operates the security camera using the controller (not shown), an image sensor 17 converts an optical signal received through the lens unit 28 into an electrical signal, the A/D converter 16 converts the electrical signal into a digital signal. And an image processor 15 processes the received digital signal, and outputs an original image at step 30.

The privacy area calculator 11 detects pan angle and tilt angle of the security camera, and determines whether the security camera captures a privacy area. If it is determined that the security camera captures a privacy area, the privacy area calculator 11 calculates coordinate values of the privacy area. After calculating the coordinate values of the privacy area, bitmap generator 12 constructs a bitmap of an original image including the privacy area at an appropriate bitmap resolution at step 32. Resolution of the bitmap interacts with the block size of the resampling image (that is, the size of the mosaic piece contained in the mosaic image), such that the bitmap generator 12 selects an appropriate value according to the degree of privacy protection or zoom ratio of lens unit 28.

At step 34, the resampling unit 13 generates a resampling image in which the original image is reconstructed in the form of a block size corresponding to bitmap resolution. The mosaic synthesizer 14 synthesizes the original image and the resampling image on the basis of the bitmap, and forms a new image in which the privacy area is distorted by a mosaic at step 36. Brightness and chrominance values are selected for the remaining non-privacy area of the original image, and brightness and chrominance values are selected for the privacy area of the resampling image, such that only the privacy area contained in the original image is distorted by a mosaic by blocks of the resampling image.

If the mosaic image is formed, controller 18 determines whether a tilt angle is in the range of 90° to 180° (that is, 90°≦tilt angle≦180°) at step 38. If the tilt angle is in the range of 90° to 180° at step 38, the upper/lower inverting unit 24 inverts the mosaic image at step 40. However, if the tilt angle is less than 90°, the upper/lower inverting unit 24 does not invert the mosaic image.

The D/A converter 26 converts a digital brightness signal and a digital chrominance signal into analog signals. The output signal synthesizer 27 synthesizes the analog brightness signal and the analog chrominance signal into a composite video signal at step 42 when the monitor is based on an analog scheme, transmits the composite video signal to the monitor (not shown), such that the composite video signal is displayed on the monitor at step 44.

As is apparent from the above description, the security camera and privacy protection method for use with the security camera according to exemplary embodiments of the present invention provide distortion of a privacy area, and display a privacy area distorted by a mosaic, thus protecting a person's privacy and retaining a security function of the privacy area.

Aspects of the present invention provides various-sized mosaic pieces according to the degree of privacy protection desired, controls resolution of the privacy area using the various-sized mosaic pieces, and thereby provides a user with an optimum security image.

Aspects of the present invention provide various-sized mosaic pieces according to zoom ratio, controls resolution of the privacy area using the various-sized mosaic pieces, and thereby provides a user with an optimum security image.

While the present invention has been particularly shown and described with reference to certain exemplary embodiments thereof, it will be understood by those of ordinary skill in the art that various changes in form and detail may be made therein without departing from the spirit and scope of the present invention as defined by the appended claims.

What is claimed is:

1. A security camera comprising:
a lens unit;
a pan/tilt/zoom drive for operating the lens unit;
an image processor for generating an original image captured by the lens unit;
a privacy area processor for reducing resolution of a privacy area, which is defined by a predetermined area of the original image, and generating a resultant image including the privacy area of low resolution; and
an output unit for transmitting images to a display.

2. The security camera according to claim 1, wherein the resolution of the privacy area is reduced by distorting the privacy area with a mosaic.

3. The security camera according to claim 2, wherein the mosaic changes size according to a zoom ratio of the security camera.

4. The security camera according to claim 2, wherein the mosaic changes size according to the degree of privacy protection desired.

5. The security camera according to claim 1, wherein the privacy area processor comprises:
a privacy area calculator for calculating the privacy area contained in the original image in consideration of privacy position information stored in a privacy area storage unit and a pan/tilt/zoom degree of the lens unit.

6. The security camera according to claim 5, wherein the privacy area processor further comprises:
a bitmap generator for constructing a bitmap of the original image including the privacy area.

7. The security camera according to claim 6, wherein the privacy area processor further comprises:
a resampling unit for dividing the original image into a plurality of blocks according to bitmap resolution, and generating a resampling image in which a mean value of brightness of all pixels contained in each divided block is set to a brightness value of the block and a mean value of chrominance of all pixels contained in the block is set to a chrominance value of the block.

8. The security camera according to claim 7, wherein the privacy area processor further comprises:
a mosaic synthesizer for selecting the resampling image in the privacy area from among the overall bitmaps, and selecting the original image in the remaining non-privacy area, such that the privacy area is distorted by a mosaic by the resampling image.

9. The security camera according to claim 1, further comprising:
an upper/lower inverting unit for vertically inverting the images if a tilt angle of the lens unit is in a predetermined range, and transmitting the inverted images to the output unit.

10. A security camera comprising:
a lens unit;
a pan/tilt/zoom drive for operating the lens unit;
an image processor for generating an original image captured by the lens unit;
a bitmap generator for constructing a bitmap of the original image;
a resampling unit for generating a resampling image formed when the original image is divided into a plurality of blocks according to bitmap resolution;
a mosaic synthesizer for converting only a privacy area of the original image into a resampling image indicative of an image distorted by a mosaic according to the bitmap; and
an output unit for transmitting images to a display.

11. A method for privacy protection for use in a security camera, the method comprising:
determining whether an original image includes a privacy area, the original image being generated by an image processor in the security camera; and
generating a new image in which resolution of the privacy area is reduced when the original image contains a privacy area.

12. The method according to claim 11, wherein the resolution of the privacy area is reduced by distorting the privacy area with a mosaic.

13. The method according to claim 12, wherein the mosaic changes size according to a zoom ratio of the security camera and degree of privacy protection desired.

14. The method according to claim 11, wherein generating the new image comprise:
generating a bitmap of the original image;
generating a resampling image formed when the original image is divided into a plurality of blocks according to bitmap resolution; and
combining the original image and the resampling image on the basis of the bitmap,
whereby the new image is constructed.

15. The method according to claim 14, wherein the mosaic size is determined according to block size.

16. The method according to claim 14, wherein the privacy area contained in the original image is replaced with the resampling image.

17. A computer readable medium for controlling privacy protection in a security camera, comprising:
a first set of instructions for determining whether an original image includes a privacy area, the original image being generated by an image processor in the security camera; and
a second set of instructions for generating a new image in which resolution of the privacy area is reduced when the original image contains a privacy area.

18. The computer readable medium of claim 17, wherein the second set of instructions comprise:
instructions for generating a bitmap of the original image;
instructions for generating a resampling image formed when the original image is divided into a plurality of blocks according to bitmap resolution; and
instructions for combining the original image and the resampling image on the basis of the bitmap,
whereby the new image is constructed.

19. The computer readable medium of claim 17, wherein the resolution of the privacy area is reduced by distorting the privacy area with a mosaic.

20. The computer readable medium of claim 19, wherein the mosaic changes size according to a zoom ratio of the security camera and degree of privacy protection desired.
